(19) United States
(12) Patent Application Publication
(10) Pub. No.: US 2015/0106861 A1
(43) Pub. Date: Apr. 16, 2015

(54) Interactive Intelligent Set-Top Box and Systems and Methods Thereof

(71) Applicant: Bichun Yu, ShenZhen (CN)

(72) Inventor: Bichun Yu, ShenZhen (CN)

(21) Appl. No.: 14/245,687

(22) Filed: Apr. 4, 2014

(30) Foreign Application Priority Data
Oct. 15, 2013 (CN) 201330484967.8
Nov. 15, 2013 (CN) 201320720306.5

(51) Int. Cl. H04N 21/462; H04N 21/4223; H04N 21/41; H04N 21/422

(52) U.S. Cl. CPC H04N 21/4622; H04N 21/42203; H04N 21/4223; H04N 21/41
USPC 725/110; 725/133

(57) ABSTRACT

An interactive intelligent set-top box electrically connected to a television, the set-top box comprising a control chip, an audio processing chip, a memory, a network interface, a camera electrically connected to the control chip, at least one loudspeaker, at least one microphone wherein the microphone and the loudspeaker electrically connected to the audio processing chip, and a housing containing at least the control chip, audio processing chip, memory, network interface, and camera, wherein the housing is removably couplable to a bracket shaped to removably attach the housing to a television. The network interface is electrically connected to a network by which it receives live video and audio data from at least one remote location. The camera and the microphone capture live video and audio data from the environment local to the interactive set-top box. The control chip and the audio processing chip process the received and captured live video and audio data and output the processed video and audio data through the at least one loudspeaker and the television in real time.

### CROSS-REFERENCE TO RELATED APPLICATIONS

This application claims priority, under 35 U.S.C. §§119 and 371, of Chinese Patent Application No. 201330484967.8, filed on Oct. 15, 2013, and Chinese Patent Application No. 201320720306.5, filed on Nov. 15, 2013, the entire disclosures of which are hereby incorporated by reference in their entireties.

### FIELD OF THE INVENTION

The present invention lies in the field of network set-top boxes. Specifically, the present invention provides an interactive intelligent set-top box that expands the range of applications to which a television can be used by allowing users to interact via a television platform.

### BACKGROUND OF THE INVENTION

Due to the popularization and development of networks, the set-top box has become increasingly accepted as a way of extending the ordinary functions of a television (TV) set. Through the set-top box, a user can use a TV set as a display and adopt a remote controller to enable the TV set to operate similar to a computer, such as browsing web pages, playing games, playing music, playing live network television programs and playing network movies on demand, etc. However, the common set-top box can only be used to play audio and video content and cannot transmit local sound and image to a remote terminal or screens of television, that is, the current set-top boxes have no interaction capability.

Accordingly, a need exists to overcome the limitations discussed above.

### SUMMARY OF THE INVENTION

In order to solve the problem of the present-day set-top box having no interactive function, the present invention provides an interactive intelligent set-top box and systems and methods thereof that overcome the hereinafore-mentioned disadvantages of the heretofore-known devices and methods of this general type.

With the foregoing and other objects in view, there is provided, in accordance with the present invention, an interactive intelligent set-top box comprising a set-top box comprising a housing, a network interface, a power interface, an audio processing chip, a control chip, a memory, at least one loudspeaker, at least one microphone, a camera and a bracket. The microphone and the loudspeaker are electrically connected to the audio processing chip. The camera and the audio processing chip are electrically connected to the control chip. The bracket comprises a clamping part and a connection part. The clamping part has a downward-extending clamping plate at one side and a downward-sunken spherical concave on its top surface, and is connected to the connection part through a hinge at a second side. The bottom surface of the set-top box has a spherical convex shaped to matingly fit the spherical concave of the clamping part of the bracket and, when the set-top box is positioned on top of the bracket, the spherical concave of the clamping part of the bracket is flexibly and removably connected with the spherical convex of the set-top box.

In accordance with another feature of the invention, the flexible connection between the spherical concave of the clamping part of the bracket and the spherical convex of the set-top box is by magnetic fixation.

In accordance with a further feature of the invention, the hinge has a lock device.

In accordance with an added feature of the invention, the clamping plate of the clamping part has an inner side with a silicone pad and an inner wall of the connection part has a silicone pad.

In accordance with an additional feature of the invention, the at least one loudspeaker is two loudspeakers and the at least one microphone is two microphones.

In accordance with yet another feature of the invention, the camera is a 5-million pixel autofocus high-definition camera.

In accordance with yet a further feature of the invention, the audio processing chip is a Digital Signal Processing (DSP) audio processing chip.

In accordance with yet an added feature of the invention, the network interface, the power interface, and the memory are electrically connected to the control chip.

With the objects of the invention in view, there is also provided a television communication device, comprising an interactive set-top box electrically connected to a television, the interactive set-top box comprising a control chip, an audio processing chip, a memory, a network interface, a camera electrically connected to the control chip, at least one loudspeaker, at least one microphone wherein the microphone and the loudspeaker electrically connected to the audio processing chip, and a housing containing at least the control chip, audio processing chip, memory, network interface, and camera, wherein the housing is removably couplable to a bracket shaped to removably attach the housing to a television. The network interface is electrically connected to a network by which it receives live video and audio data from at least one remote location. The camera and the microphone capture live video and audio data from the environment local to the interactive set-top box. The control chip and the audio processing chip process the received and captured live video and audio data and output the processed video and audio data through the at least one loudspeaker and the television in real time.

In accordance with a concomitant feature of the invention, the bracket comprises a clamping part having a top surface, a downward-extending clamping plate at a first side, a second side, and a downward-sunken spherical concave on the top surface and a connection part connected to the clamping part through a hinge at the second side, and the shell has a bottom surface with a correspondingly spherical convex shape to matingly fit the spherical concave of the clamping part and, when the housing is positioned on top of the clamping part, the spherical concave of the clamping part of the bracket is removably connected with the spherical convex with a magnetic connection device.

Although the invention is illustrated and described herein as embodied in an interactive intelligent set-top box and systems and methods thereof, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to further illustrate various embodiments and to explain various principles and advantages in accordance with the present invention. Advantages of embodiments of the present invention will be apparent from the following detailed description of the exemplary embodiments thereof, which description should be considered in conjunction with the accompanying drawings in which:

FIG. 1 is an exploded perspective view of an interactive intelligent set-top box, and a bracket of the set-top box, in accordance with an exemplary embodiment;

FIG. 2 is an enlarged, perspective view of the bracket of FIG. 1;

FIG. 3 is a bottom plan view of the interactive intelligent set-top box of FIG. 1;

FIG. 4 is a rear perspective view of the interactive intelligent set-top box and the bracket of FIG. 1 with the set-top box assembled with the bracket;

FIG. 5 is a block structure diagram of an interactive intelligent set-top box in accordance with an exemplary embodiment;

FIG. 6 is a front elevational view of an exemplary embodiment of an interactive intelligent set-top box;

FIG. 7 is a rear elevational view of the interactive intelligent set-top box of FIG. 6;

FIG. 8 is a top plan view of the interactive intelligent set-top box of FIG. 6;

FIG. 9 is a bottom plan view of the interactive intelligent set-top box of FIG. 6;

FIG. 10 is a left elevational view of the interactive intelligent set-top box of FIG. 6;

FIG. 11 is a right elevational view of the interactive intelligent set-top box of FIG. 6;

FIG. 12 is a front perspective view of the interactive intelligent set-top box of FIG. 6 with a bracket;

FIG. 13 is a front elevational view of the bracket of FIG. 12;

FIG. 14 is a rear elevational view of the bracket of FIG. 12;

FIG. 15 is a top plan view of the bracket of FIG. 12;

FIG. 16 is a bottom plan view of the bracket of FIG. 12;

FIG. 17 is a left elevational view of the bracket of FIG. 12; and

FIG. 18 is a right elevational view of the bracket of FIG. 12.

### DETAILED DESCRIPTION OF THE INVENTION

As required, detailed embodiments of the present invention are disclosed herein; however, it is to be understood that the disclosed embodiments are merely exemplary of the invention and can be embodied in various forms. Therefore, the specific structural and functional details that are disclosed herein are not to be interpreted as limiting, but merely as a basis for any claims and as a representative basis for teaching one skilled in the art to variously employ the present invention in virtually any appropriately detailed structure. Further, the terms and phrases that are used herein are not intended to be limiting; but rather, to provide an understandable description of the invention. While the specification may conclude with claims defining the features of the invention that are regarded to be novel, it is believed that the invention will be better understood from a consideration of the following description in conjunction with the drawing figures in which like reference numerals are carried forward.

### DEFINITIONS

Before the present invention is disclosed and described, it is to be understood that the terminology herein is not intended to be limiting and is only being used for the purpose of describing particular embodiments. Unless otherwise specified, all technological terms used herein have the same meaning as commonly understood by one of ordinary skill in the art to which the present invention belongs.

As used herein, the terms “a” or “an”, are defined as one or more than one. The term “plurality”, as used herein, is defined as two or more than two. The term “another”, as used herein, is defined as at least a second or more.

As used herein, the terms “including” and/or “having”, are defined as comprising (i.e., open language). The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, relational terms, such as first and second, may be used solely to distinguish one entity or action from another entity or action without necessarily requiring or implying any actual such relationship or order between such entities or actions.

As used herein, the term “coupled” is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

As used herein, the terms “component,” “system,” “database,” and “server” are intended to refer to a computer-related entity, either hardware, a combination of hardware and software, software, or software in execution. The terms “program,” “software,” “software application,” and the like as used herein, are defined as a sequence of instructions designed for execution on a computer system. In addition, a “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

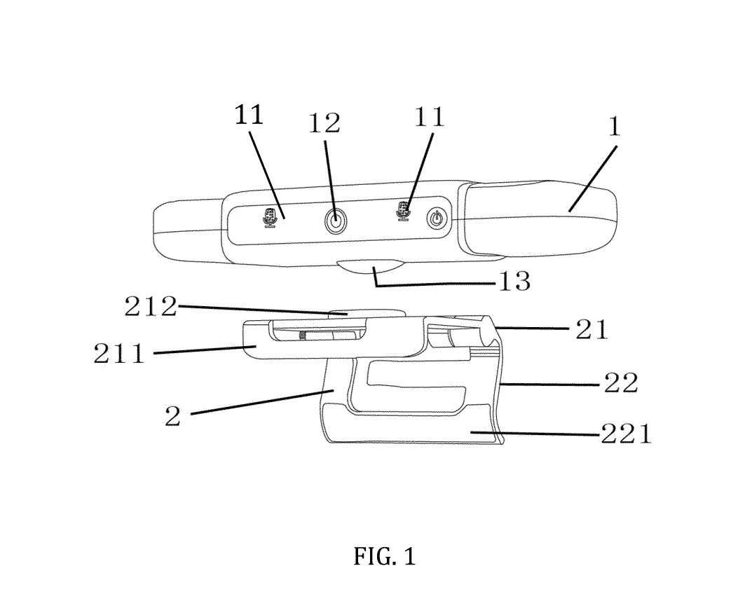

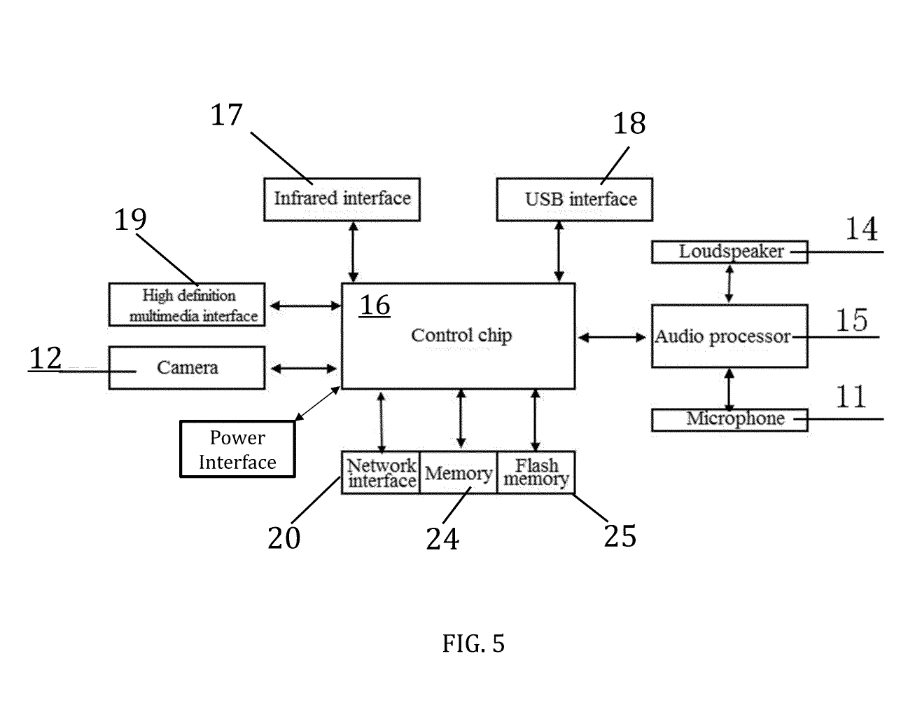

Referring now to the figures of the drawings in detail and first, particularly to FIGS. 1 and 5, there is shown an exemplary embodiment of an interactive intelligent set-top box 1 and a corresponding bracket 2 of the present invention. The set-top box 1 comprises a housing, an audio interface, a network interface, a power interface, an HDMI interface, a USB interface, an infrared interface, a display panel, a power switch, a control chip, a memory and a flash memory.

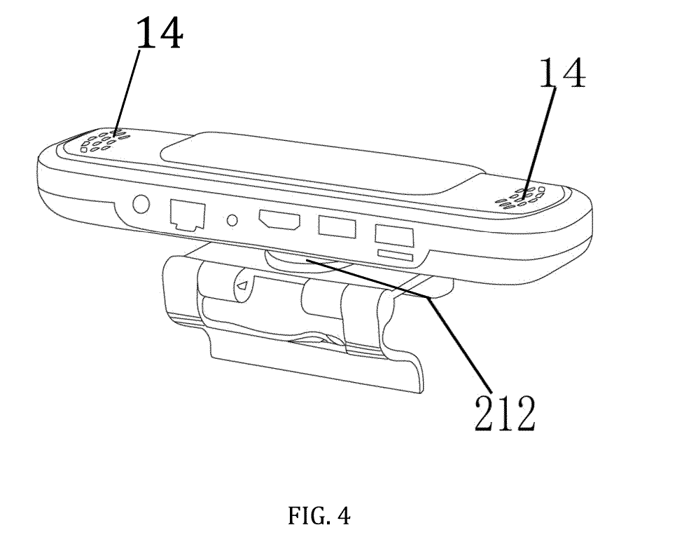

As shown in FIGS. 4 and 5, the set-top box 1 is further provided with a processing chip 15 that is, for example, a Digital Signal Processing (DSP) audio processor chip. Further, the set-top box is provided with two loudspeakers 14, two microphones 11, and cameras 12. The microphones 11 and the speakers 14 are electrically connected to the audio processor chip 15. The audio processor chip 15 and the camera 12 are electrically connected to a control chip 16. The camera 12 is, for example, a 5-million pixel autofocus high-definition camera.

The control chip 16 is also connected to one or more of an infrared interface 17, a USB interface 18, a high definition multimedia interface 19, a network interface 20, a memory 24, and/or a flash memory 25.

As mentioned above, the audio processing chip 15 adopted in the exemplary illustration is a DSP audio processing chip. Inside the chip 15 high-frequency signals are eliminated through processing of a low noise amplifier, a low pass filter, and an automatic grain control device. The noise reduction system effectively eliminates linear noise, non-linear noise and high-frequency signals. The chip 15 can regulate de-noising algorithm and amplified parameters, so as to extract effective voice signals as possible.

At the same time, the technical scheme of the present disclosure adopts two high sensitivity array type microphones 11 combined with the DSP audio processing chip 15 to improve the dynamic range of the microphones 11. Meanwhile, it uses the dual microphones 11 to realize a selection of the voice source, enhance voice volume from the front and inhibit volume of noise from the sides.

In addition, the integrated loudspeaker 14 can receive the audio information from far ends that form an echo via the microphone 11 and process it via the DSP processing chip 15. The known echo component is subtracted through processing of the DSP processing chip 15, thus only the voice of local users is delivered, which realizes the function of eliminating echo.

Further, as mentioned above, the exemplary scheme adopts a 5-million pixel autofocus high-definition camera, which can provide clear images to help transmit clear image information to far or remote ends.

Additionally, as mentioned above, the interactive intelligent set-top box 1 is further provided with a microphone 11 and a camera 12, which can input local and far or remote-end audio and video images into the control chip 16, and the control chip 16 conducts corresponding processing of the gained audio and video information, then provides corresponding output, so as to realize the interaction between a user and a TV set and/or a remote user. Accordingly, the applicable range of use or capability of the conventional set-top box is expanded to include user interaction.

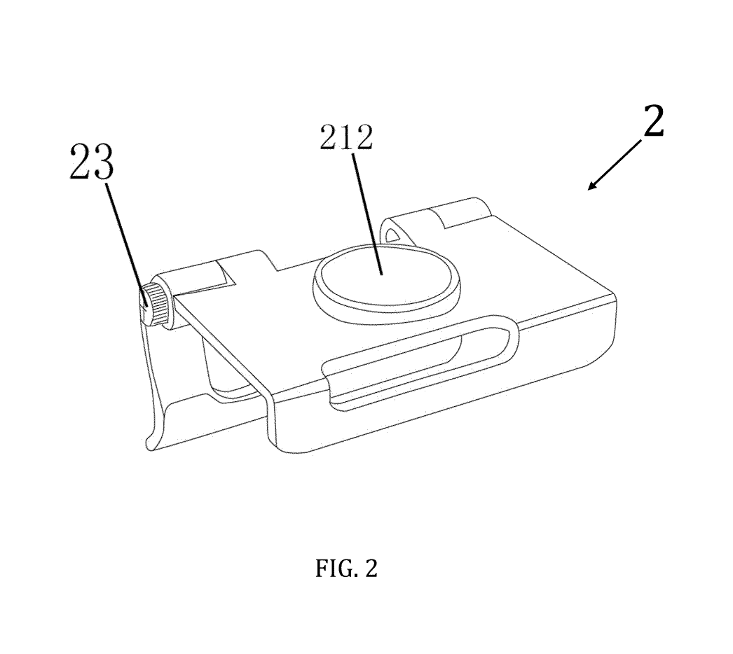

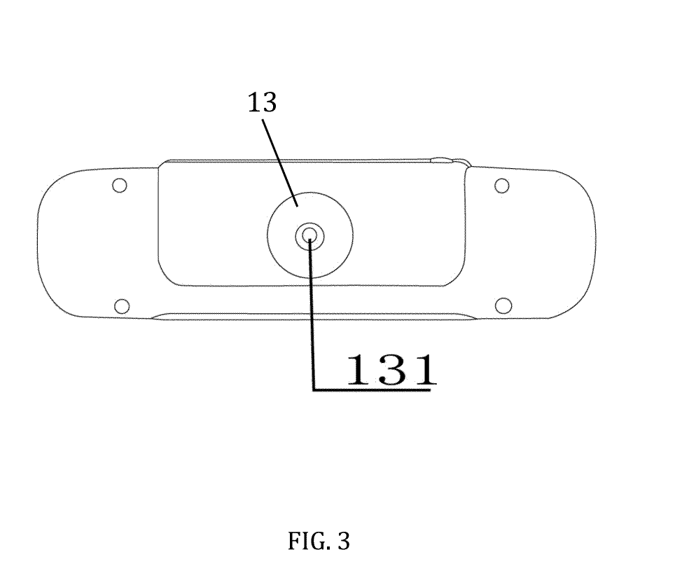

Shown in close detail in FIGS. 1 and 2 is an exemplary embodiment of a support bracket 2 for use with the interactive intelligent set-top box 1. The bracket 2 is comprised of a clamping part 21 and a connection part 22. The clamping part 21 is provided with a downward-extending clamping plate 211, and the clamping plate 211 is provided with a silicone pad inside. The clamping part is provided with a downward spherical concave 212 on the top, and the other side is connected with the connection part 22 through a hinge, wherein the hinge joint is provided with a lock device 23. The inner wall of the connection part 22 is provided with a silicone pad 221. See FIG. 1. As shown in FIG. 3, the bottom of the set-top box 1 is provided with a spherical convex 13 fitting the spherical concave 212 of the bracket clamping part 21. As shown in FIG. 1, the spherical concave 212 on top of the clamping part 21 is flexibly connected with the spherical convex 13 of the set-top box 1. Further, as shown in FIG. 3, the spherical concave 212 of the clamping part 21 is made from a material easy to be attracted by a magnet, which is flexibly connected with the spherical convex 13 of the set-top box 1 through magnetic attraction with magnet 131, the magnet 131 being placed, for example, inside the spherical convex 13. Alternatively, or in conjunction with the magnet 131, one or more screws may be used to attach the set-top box 1 to the support bracket 2.

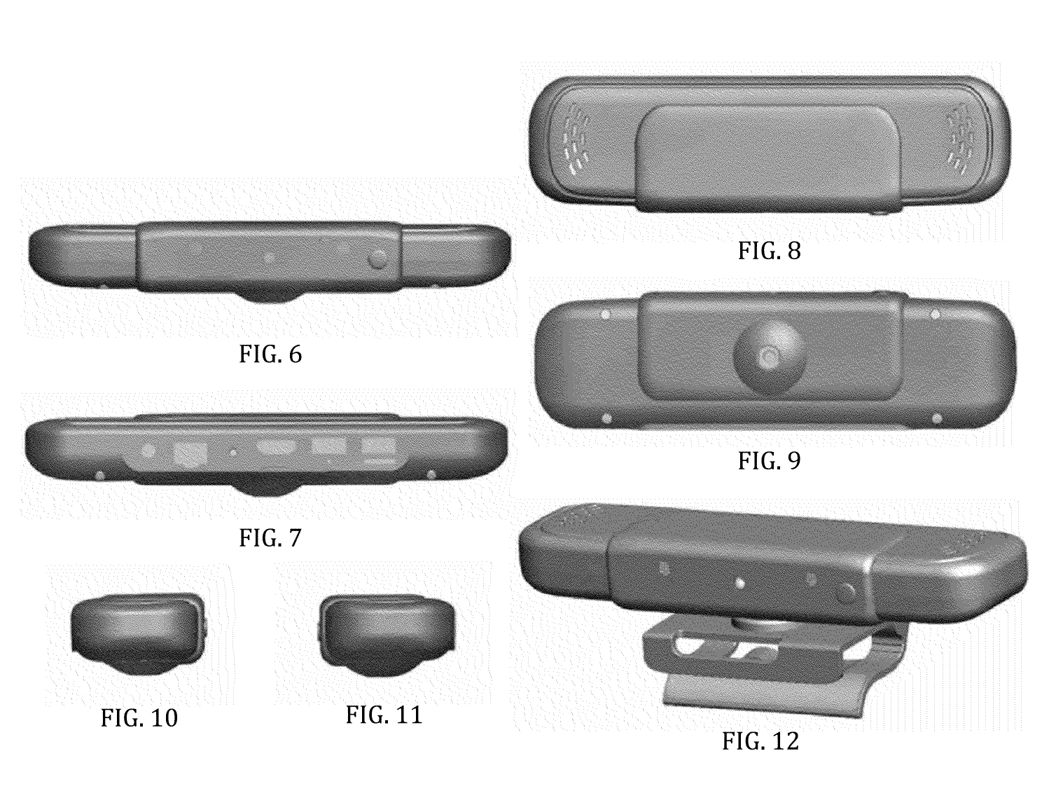

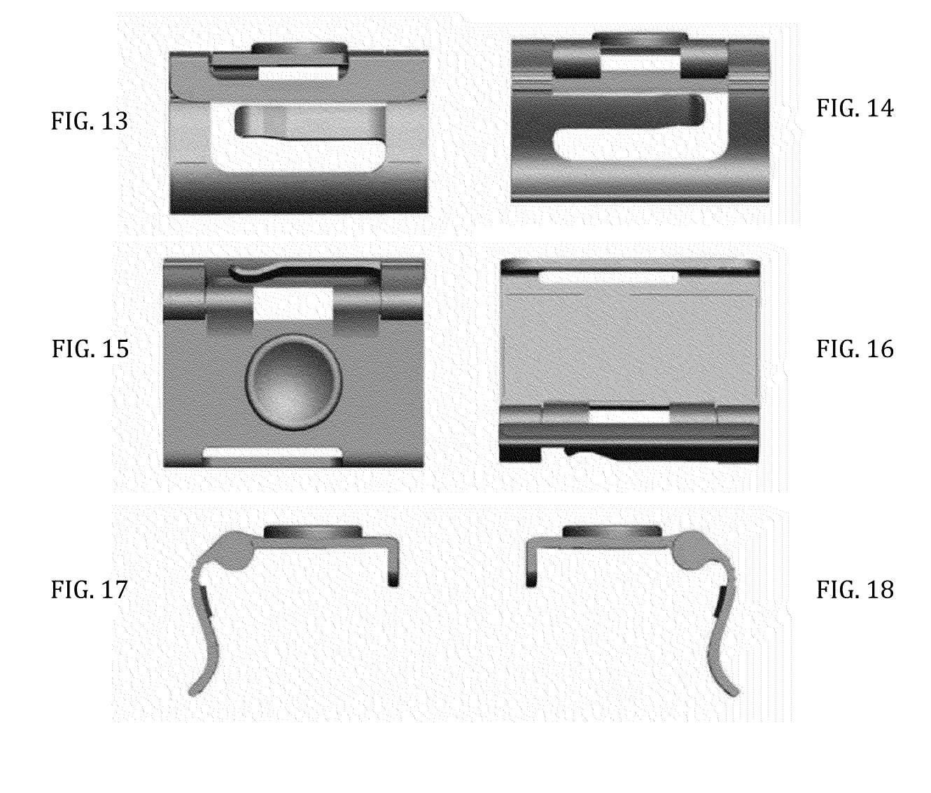

FIG. 6 through FIG. 12 also show an exemplary embodiment of the set-top box 1 and FIG. 12 through FIG. 18 also show an exemplary embodiment of the support bracket 2.

The foregoing description and accompanying drawings illustrate the principles, preferred embodiments and modes of operation of the present invention. However, the present invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

What is claimed is:

1. An interactive intelligent set-top box, comprising:
a set-top box comprising:
a housing;
a network interface;
a power interface;
an audio processing chip;
a control chip;
a memory;
at least one loudspeaker;
at least one microphone; and
a camera, wherein:
the microphone and the loudspeaker are electrically connected to the audio processing chip; and
the camera and audio processing chip are electrically connected to the control chip;
a bracket comprising a clamping part and a connection part, wherein the clamping part has a downward-extending clamping plate at one side and a downward-sunken spherical concave on its top surface, and is connected to the connection part through a hinge at a second side; and
a bottom surface of the set-top box has a spherical convex shaped to matingly fit the spherical concave of the clamping part of the bracket and when the set-top box is positioned on top of the bracket, the spherical concave of the clamping part of the bracket being flexibly connected with the spherical convex of the set-top box.

2. The interactive intelligent set-top box according to claim 1, wherein the flexible connection between the spherical concave of the clamping part of the bracket and the spherical convex of the set-top box is by magnetic fixation.

3. The interactive intelligent set-top box according to claim 1, wherein the hinge has a lock device.

4. The interactive intelligent set-top box according to claim 1, wherein:
the clamping plate of the clamping part has an inner side with a silicone pad; and
an inner wall of the connection part has a silicone pad.

5. The interactive intelligent set-top box according to claim 1, wherein:
the at least one loudspeaker is two loudspeakers; and
the at least one microphone is two microphones.

6. The interactive intelligent set-top box according to claim 1, wherein the camera is a 5-million pixel autofocus high-definition camera.

7. The interactive intelligent set-top box according to claim 1, wherein the audio processing chip is a Digital Signal Processing (DSP) audio processing chip.

8. The interactive intelligent set-top box according to claim 1, wherein the network interface, the power interface, and the memory are electrically connected to the control chip.

9. A television communication device, comprising:
an interactive set-top box electrically connected to a television, the interactive set-top box comprising:
a control chip;
an audio processing chip;
a memory;
a network interface;
a camera electrically connected to the control chip;
at least one loudspeaker;
at least one microphone, the microphone and the loudspeaker electrically connected to the audio processing chip; and
a housing:
containing at least the control chip, audio processing chip, memory, network interface, and camera; and
removably couplable to a bracket shaped to removably attach the housing to a television;
wherein:
the network interface is electrically connected to a network by which it receives live video and audio data from at least one remote location;
the camera and the microphone capture live video and audio data from the environment local to the interactive set-top box; and
the control chip and the audio processing chip process the received and captured live video and audio data and output the processed video and audio data through the at least one loudspeaker and the television in real time.

10. The television communication device according to claim 9, wherein the bracket is removably couplable to the housing using a magnetic connection device.

11. The television communication device according to claim 10, wherein:
the bracket comprises:
a clamping part having a top surface, a downward-extending clamping plate at a first side, a second side, and a downward-sunken spherical concave on the top surface; and
a connection part connected to the clamping part through a hinge at the second side; and
the housing has a bottom surface with a correspondingly spherical convex shape to matingly fit the spherical concave of the clamping part and, when the housing is positioned on top of the clamping part, the spherical concave of the clamping part of the bracket is removably connected with the spherical convex with the magnetic connection device.
